(19) United States
(12) Patent Application Publication
(10) Pub. No.: US 2020/0360817 A1
(43) Pub. Date: Nov. 19, 2020

(54) INFORMATION PROCESSING DEVICE AND METHOD TO EXECUTE GAME

(71) Applicant: Kabushiki Kaisha Sega Games doing business as Sega Game Co., Ltd., Tokyo (JP)

(72) Inventor: Takahiro Otomo, Tokyo (JP)

(73) Assignee: Kabushiki Kaisha Sega Games doing business as Sega Game Co., Ltd., Tokyo (JP)

(21) Appl. No.: 16/983,403

(22) Filed: Aug. 3, 2020

Related U.S. Application Data
(63) Continuation of application No. 16/172,433, filed on Oct. 26, 2018, now abandoned.
Application No. 16/172,433 is a continuation of application No. PCT/JP2017/011499, filed on Mar. 22, 2017.

(30) Foreign Application Priority Data
Apr. 27, 2016 (JP) 2016-089868

(51) Int. Cl. A63F 13/69; A63F 13/533; A63F 13/825; A63F 13/2145

(52) U.S. Cl. CPC A63F 13/69; A63F 13/533; A63F 13/426; A63F 13/2145; A63F 13/825

(57) ABSTRACT

An information processing device includes: a receiver that receives a slide gesture input and a tap gesture input on a touch panel that displays a screen of the game; and a processor that, once a user completes a quest of the game, causes the touch panel to display a screen indicating contents and a confirmation button. Upon detecting the slide gesture input, the processor determines that desired contents have been continuously selected from the contents. The slide gesture input is based on a slide gesture by which the desired contents have been continuously touched. Upon detecting the tap gesture input, the processor determines that the desired contents have been confirmed to be selected. The tap gesture input is based on a tap gesture on the confirmation button. A space between each of the contents and the confirmation button is at least a size of each of the contents.

### CROSS-REFERENCE TO RELATED APPLICATIONS

This is a continuation application of U.S. application Ser. No. 16/172,433 filed Oct. 26, 2018, which claims priority to International Application No. PCT/JP2017/011499 filed Mar. 22, 2017, and Japanese Patent Application No. 2016-089868 filed Apr. 27, 2016. The entirety of these applications are incorporated herein by reference.

### TECHNICAL FIELD

The present invention relates to an information processing device and a method.

### BACKGROUND

There is a known information processing device that allows a user to play a game in which characters (an example of content) are sold, or fusions are performed between characters as fusion resources and characters as fusion sources (for example, Patent Literature 1).

Patent Literature 1: JP-A 2014-133145

When selling a character, the user must perform an operation to display a selling screen, and then an operation to select the character to be sold. When fusing characters serving as fusion sources, it is necessary to perform an operation to display a fusion screen, and then an operation to select the character serving as the fusion resource. If there are a number of different kinds of operation category for characters, such as selling, fusion, etc., each operation would take time, and the operations would be complicated for the user.

### SUMMARY

One or more embodiments of the present invention provide an improvement over existing gaming technologies by simplifying various operations performed by the user and improve operability.

In one or more embodiments of the present invention, an information processing device that enables a user to play a game in which contents serving as selling objects are sold and contents serving as fusion resources are fused with contents serving as fusion sources comprises:
a screen display that displays a screen including one or a plurality of first contents, one or a plurality of second contents serving as fusion sources, and a third content that is different from the first content and the second content; and
an operation input receiver that accepts a first operation input for selecting a first content as content serving as a fusion resource of a second content when a position on the screen designated by the user while the screen is being displayed moves between the display position of any of the first contents and the display position of any of the second contents, and the movement of the designated position ends at the display position of the first content or the display position of the second content, and accepts a second operation input for selecting the first content as content serving as a selling object when a designated position on the screen designated by the user moves between the display position of any of the first contents and the display position of the third content, and the movement of this designated position ends at the display position of the first content or the display position of the third content.

With this information processing device, the various operations performed by the user are simplified, enabling improved operability over conventional information processing devices.

Also, the operation input receiver may accept the second operation input for also selecting another first content as content serving as a selling object when the designated position has passed through the display position of the other first content while moving between the display position of the first content and the display position of the third content.

This enables contents serving as selling objects to be selected collectively, which enables further improvements in operability.

An information processing device of one or more embodiments of the present invention that also enables a user to play a game in which contents serving as selling objects are sold and contents serving as fusion resources are fused with contents serving as fusion sources, said device comprising:
a screen display that displays a screen including one or a plurality of the first contents and one or a plurality of the second contents serving as fusion sources; and
an operation input receiver that accepts a first operation input for selecting the first content as content serving as a fusion resource of the second content when a position on the screen designated by the user while the screen is being displayed moves between the display position of any of the first contents and the display position of any of the second contents, and the movement of this designated position ends at the display position of the first content or the display position of the second content, and accepts a second operation input for selecting the first content as content serving as a selling object when a designated position on the screen designated by the user is located at the display position of any of the first contents.

With this information processing device, the various operations performed by the user are simplified, enabling improved operability.

Also, the operation input receiver may accept the first operation input for also selecting another first content as content serving as a fusion resource of the second content when the designated position has passed through the display position of the other first content while moving between the display position of the first content and the display position of the second content.

This enables contents serving as fusion resources of the second contents to be selected collectively, which enables further improvements in operability.

Also, in one or more embodiments of the present invention, the information processing device may further comprise a display controller that controls the screen display so that the lower the rarity setting for the first content, the closer its display position is to the display position of the third content.

Consequently, the higher the probability that a first content will be selected as content serving as a selling object by the user, the closer it is displayed to the third content, which makes the second operation input easier to perform.

Also, in one or more embodiments of the present invention, the information processing device may further comprise a display controller that controls the screen display so that the more the first content is set for dedicated use as a fusion resource, the closer its display position is to the display position of the second content.

Consequently, the higher the probability that a first content will be selected as content serving as a fusion resource by the user, the closer it is displayed to the second content, which makes the first operation input easier to perform.

Also, the display controller may control the screen display so as to change the display position of the first content according to the rarity setting for the first content.

This makes it easier to select the first content when performing the first operation input and the second operation input.

Also, the display controller may control the screen display so as to change the size of the second content display area according to the number of second contents displayed on the screen.

This reduces operation errors when performing the first operation input.

In one or more embodiments of the present invention, a method for causing a computer to execute a game including:
displaying a screen including one or a plurality of first contents, one or a plurality of second contents serving as fusion sources, and a third content that is different from the first content and the second content; and
accepting a first operation input for selecting the first content as content serving as a fusion resource of the second content when a position on the screen designated by the user while the screen is being displayed moves between the display position of any of the first contents and the display position of any of the second contents, and the movement of the designated position ends at the display position of the first content or the display position of the second content, and for accepting a second operation input for selecting the first content as content serving as a selling object when a position on the screen designated by the user moves between the display position of the first content and the display position of the third content, and the movement of this designated position ends at the display position of the first content or the display position of the third content. With this type of program, the various operations performed by a user are simplified, enabling improved operability.

In one or more embodiments of the present invention, a method for causing a computer to execute a game including:
displaying a screen including one or a plurality of first contents and one or a plurality of second contents serving as fusion sources; and
accepting a first operation input for selecting the first content as content serving as a fusion resource of the second content when a position on the screen designated by the user while the screen is being displayed moves between the display position of any of the first contents and the display position of any of the second contents, and the movement of this designated position ends at the display position of the first content or the display position of the second content, and for accepting a second operation input for selecting the first content as content serving as a selling object when a designated position on the screen designated by the user is located at the display position of any of the first contents.

With this method, the various operations performed by the user are simplified, enabling improved operability.

An information processing device that executes a game includes: a receiver that receives an input based on a user's operation on a touch panel that displays a screen of the game; and a processor that detects the input. Upon completing a quest of the game, the processor causes the touch panel to display a screen that indicates contents to be acquired by the user and a confirmation button spaced apart from each of the contents. Upon detecting a first input, the processor determines that first contents have been continuously selected from the contents, the first input is based on a slide gesture of the user by which the first contents have been continuously touched. Upon detecting a second input, the processor determines that the first contents have been confirmed to be selected. The second input is based on a tap gesture on the confirmation button. A space between each of the contents and the confirmation button is at least a size of each of the contents.

A method to execute a game on a computer includes: receiving an input based on a user's operation on a touch panel that displays a screen of the game; upon completing a quest of the game, causing the touch panel to display a screen that indicates contents to be acquired by the user and a confirmation button spaced apart from each of the contents; detecting a first input based on a slide gesture of the user by which first contents among the contents have been continuously touched; determining that first contents have been continuously selected from the contents based on the detection of the first input; detecting a second input based on a tap gesture on the confirmation button; and determining that the first contents have been confirmed to be selected based on the detection of the second input. A space between each of the contents and the confirmation button is at least a size of each of the contents.

### BRIEF DESCRIPTION OF DRAWINGS

FIG. 1 is a configuration diagram showing an example of an information processing system.

FIG. 2 is a hardware configuration diagram showing an example of a computer.

FIG. 3 is a functional block diagram showing an example of a server device.

FIG. 4 is a functional block diagram showing an example of a client terminal.

FIG. 5 is a flowchart showing an example of the processing when the user selects a character on the acquisition screen.

FIG. 6 is a configuration diagram showing an example of user information.

FIG. 7 is a configuration diagram showing an example of character information.

FIG. 8 is a configuration diagram showing an example of quest information.

FIG. 9 is a configuration diagram showing an example of lottery game information.

FIG. 10 is a conceptual diagram showing an example of a first acquisition screen.

FIG. 11 is a conceptual diagram showing an example of a confirmation screen.

FIG. 12 is a flowchart showing an example of the processing when the user selects a character on the possession screen.

FIG. 13 is a conceptual diagram showing an example of a first possession screen.

FIG. 14 is a flowchart showing another example of the processing when the user selects a character on the acquisition screen.

FIG. 15 is a conceptual diagram showing an example of a second acquisition screen.

FIG. 16 is a flowchart showing another example of the processing when the user selects a character on the possession screen.

FIG. 17 is a conceptual diagram showing an example of a second possession screen.

FIG. 18 is a flowchart showing another example of the processing when the user selects a character on the acquisition screen.

FIG. 19 is a conceptual diagram showing an example of a third acquisition screen.

FIG. 20 is a flowchart showing another example of the processing when the user selects a character on the acquisition screen.

FIG. 21 is a conceptual diagram showing an example of a fourth acquisition screen.

### DETAILED DESCRIPTION

Embodiments of the present invention will be described below in detail with reference to the drawings. However, embodiments of the present invention described below are nothing but an example, and are not intended to exclude the application of various modifications or techniques not specifically expressed below. That is, embodiments of the present invention can be modified in various ways without departing from the gist thereof. Also, in the discussion of the drawings below, portions that are the same or similar will be assigned the same or similar reference signs. The drawings are simplified, and do not necessarily match the actual dimensions, proportions, and so forth. From one drawing to the next, there may be portions in which the dimensional relations and proportions are not the same.

The information processing device, method, and information processing system pertaining to the following one or more embodiments of the present invention will now be described in detail. The following one or more embodiments of the present invention can be broadly applied to any information processing device, information processing system, or the like employing a game that is able to utilize a plurality of operation category types (selling and fusion of contents, etc.)

### EMBODIMENTS

### <System Configuration>

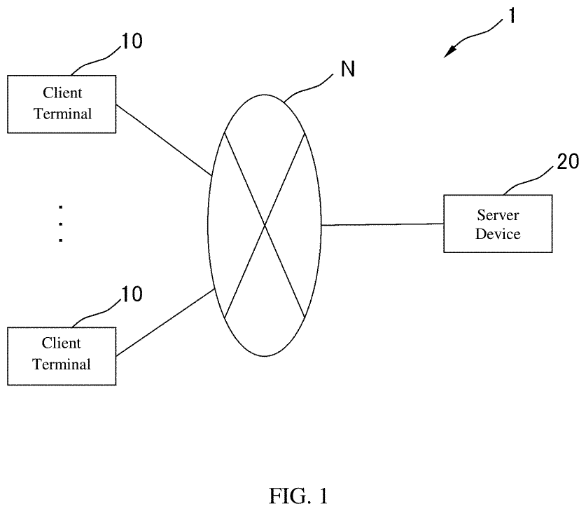

FIG. 1 is a configuration diagram showing an example of the information processing system 1 pertaining to one or more embodiments. As shown in FIG. 1, in the information processing system 1 pertaining to one or more embodiments, one or more client terminals 10 and a server device 20 are connected via a network N.

The client terminal 10 is a terminal device such as a PC, a smartphone, a tablet, or the like operated by a user, or is a terminal device such as a dedicated game device for home or commercial use. The server device 20 manages and controls a game played by the user on the client terminal 10, performs billing processing within the game, and so forth. The network N is the Internet or the like, and includes a mobile wireless base station and the like.

One or more embodiments of the present invention can be applied to a client/server type of information processing system 1 as shown in FIG. 1, as well as to a single game device (information processing device) by additionally providing some way to perform billing processing within the game. It should go without saying that the information processing system 1 in FIG. 1 is just an example, and that various system configurations are possible depending on the application and purpose. For instance, the server device 20 in FIG. 1 may be configured to be distributed among a plurality of computers.

<Hardware Configuration>

### Client Terminal and Server Device

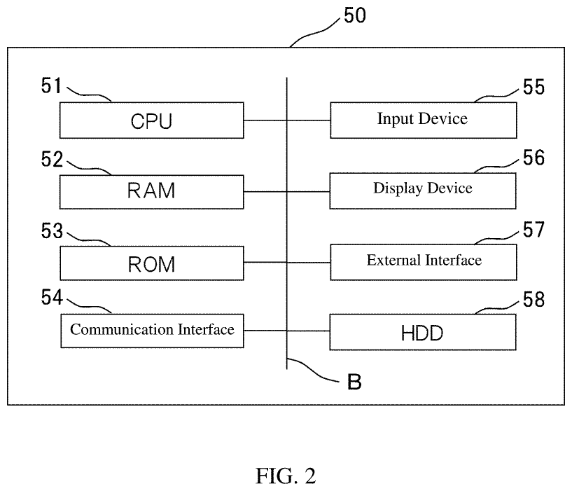

FIG. 2 is a hardware configuration diagram showing an example of the computer 50 pertaining to one or more embodiments. The client terminals 10 and the server device 20 pertaining to one or more embodiments are realized by the computer 50 having the hardware configuration shown in FIG. 2, for example. The computer 50 is an example of an information processing device.

As shown in FIG. 2, the computer 50 comprises a CPU 51, a RAM 52, a ROM 53, a communication interface 54, an input device 55, a display device 56, an external interface 57, an HDD 58, and the like, which are coupled to one another via a bus line B. In the server device 20, the input device 55 and the display device 56 may be configured so that they are connected and used only when necessary.

The CPU 51 is an arithmetic apparatus that reads instruction codes (or a program) and data from a storage device such as the ROM 53 and the HDD 58 to the RAM 52, and executes various kinds of processing based on the read program and data, so as to realize the control and functions of the entire computer.

The RAM 52 is an example of a volatile semiconductor memory (storage device) for temporarily holding instruction codes and data, and is also used as a work area when the CPU 51 executes various processing.

The ROM 53 is an example of a nonvolatile semiconductor memory (storage device) that can hold instruction codes and data even when the power is switched off. The ROM 53 stores instruction codes and data such as network settings, OS settings and BIOS that are executed when the computer 50 is started up.

The communication interface 54 is an interface for connecting the computer 50 to the network N. This allows the computer 50 to perform data communication via the communication interface 54.

The input device 55 is a device used by a user or an administrator to input various signals. The input device 55 is, for example, a touch panel, operation keys or buttons, a keyboard or a mouse, or another such operation device.

The client terminal 10 in one or more embodiments has a touch panel at minimum. The touch panel is composed of, for example, a pressure-sensitive or electrostatic panel laminated on the display device 56, and detects a designated position (touch position) on the screen by a touch operation with the user's finger, a touch pen, or the like.

The display device 56 is a device for displaying various kinds of information on the screen to a user or a manager. The display device 56 is, for example, a display such as liquid crystal or organic EL.

The external interface 57 is an interface for connecting so as to enable data communication with an external device. This allows the computer 50 to read from and/or write to a recording medium via the external interface 57. The external device is, for example, a recording medium such as a flexible disk, a CD, a DVD, an SD memory card, a USB memory, or the like.

The HDD 58 is an example of a nonvolatile storage device that stores instruction codes and data. The instruction codes and data that are stored include an OS which is basic software for controlling the entire computer, and applications that provide various functions in the OS.

A drive device (such as a solid state drive: SSD) using a flash memory as a storage medium may be used instead of the HDD 58.

The client terminals 10 and the server device 20 pertaining to one or more embodiments can realize various kinds of processing (discussed below) by executing instruction codes in the computer 50 having the hardware configuration described above.

<Software Configuration>

### Server Device

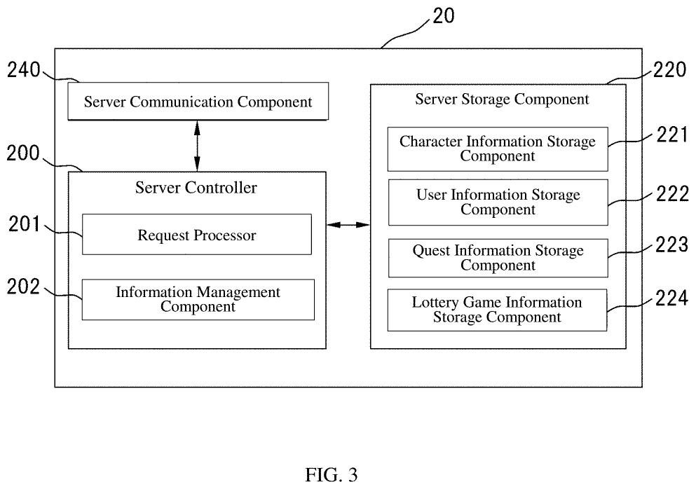

FIG. 3 is a functional block diagram showing an example of the server device 20 pertaining to one or more embodiments. The server device 20 pertaining to one or more embodiments is realized by the functional blocks shown in FIG. 3, for example.

The server device 20 pertaining to one or more embodiments realizes a server controller 200, a server storage component 220, and a server communication component 240 by executing instruction codes.

The server controller 200 has a function of executing processing related to various games in the server device 20. The server controller 200 includes a request processor 201 and an information management component 202.

The request processor 201 receives a request from the client terminal 10, performs processing corresponding to the request, and transmits the processing result and the like as a response to the client terminal 10.

The information management component 202 stores various kinds of information about the user playing the game as user information in the user information storage component 222. Also, the information management component 202 refers to and updates user information and the like in response to a request from the request processor 201.

The server storage component 220 has a function of storing information related to various kinds of games. The server storage component 220 includes a character information storage component 221, a user information storage component 222, a quest information storage component 223, and a lottery game information storage component 224.

The character information storage component 221 is an example of a content information storage component, and stores character information (content information) related to characters, which is an example of content. Various characters used in a battle game, a lottery game, and a fusion game and so forth are configured in the character information stored by the character information storage component 221.

The user information storage component 222 stores user information related to the user. The ranking of the user, the various characters possessed by the user, the point total, and so forth are configured in the user information stored by the user information storage component 222.

The quest information storage component 223 stores quest information related to quests. Various characters that can be acquired in those quests, the point consumption, and so forth are configured in the quest information stored by the quest information storage component 223.

The lottery game information storage component 224 stores lottery game information related to lottery games. Various characters that can be acquired in those lottery games and so forth are configured in the lottery game information stored by the lottery game information storage component 224.

The server communication component 240 has a function of communicating with the client terminal 10 via the network N.

Client Terminal

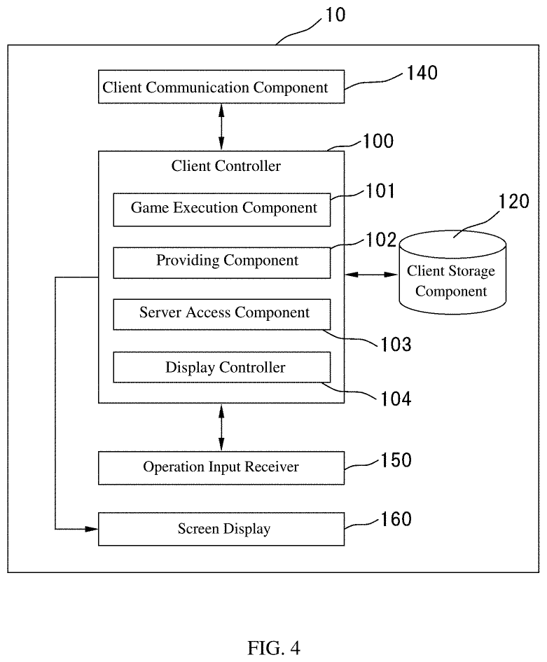

FIG. 4 is a functional block diagram showing an example of a client terminal 10 pertaining to one or more embodiments. The client terminal 10 pertaining to one or embodiments is realized by the functional blocks shown in FIG. 4, for example.

The client terminal 10 pertaining to one or more embodiments executes instruction codes to realize a client controller 100, a client storage component 120, a client communication component 140, an operation input receiver 150, and a screen display 160.

The client controller 100 has a function of executing processing related to various games. The client controller 100 includes a game execution component 101, a providing component 102, a server access component 103, and a display controller 104.

The game execution component 101 controls the progress of various games discussed below, such as a battle game, a lottery game, and a fusion game, on the basis of the game operation received from the user by the client terminal 10.

The providing component 102 provides the user one or more characters from among the plurality of characters configured in the character information discussed below in the course of processing a battle game or a lottery game.

The server access component 103 transmits various processing requests to the server device 20 and also receives responses such as processing results from the server device 20 in the event that access to the server device 20 is required during the processing of the game execution component 101, etc.

The display controller 104 controls the screen display of the client terminal 10 according to the progress of a battle game, a lottery game, a fusion game, or the like by the game execution component 101, for example. The screen display processing performed by the display controller 104 will be described in detail below.

The operation input receiver 150 receives an operation from the user operating the client terminal 10. Since the client terminal 10 in one or more embodiments has a touch panel as mentioned above, it can receive operations from the user specific to a touch panel, such as a tap, swipe, or flick operation. The information received by the operation input receiver 150 may be processed by the processor like CPU in the client terminal 10. Thus, CPU may receive or accept operation inputs through the input devices like the touch panel etc. The operation input receiver 150 can include the input devices like the touch panel etc. and the processors like CPU.

The client storage component 120 stores various kinds of information required in the client terminal 10. The client communication component 140 communicates with the server device 20. The screen display 160 displays the screen of the client terminal 10 according to the control of the display controller 104.

As described above, game progress and display control of the information processing system 1 pertaining to one or more embodiments are performed by the client terminal 10, but they may instead be performed by the server device 20. Specifically, the client controller 100 of the client terminal 10 may be configured without either the game execution component or the display controller, while the client controller 100 of the client terminal 10 may be configured with the server control 200 of the server 20.

Also, the client controller 100 of the client terminal 10 may be a browser type that receives page data written in HTML (Hyper Text Markup Language) or the like, scripts included in the page data, and the like from the server device 20, and performs processing relating to the game. The client controller 100 of the client terminal 10 may also be an application type that performs processing relating to the game based on an installed application. FIG. 4 shows the application type as an example.

<Game Overview>

An overview of the game in one or more embodiments will now be given. The games in one or more embodiments include at least a battle game, a lottery game, and a fusion game.

In one or more embodiments, a battle game is a game in which enemy characters appear against a party made up of a plurality of characters, and the various characters that make up the party do battle with the appearing enemy characters.

In this battle game, a plurality of quests is set up, according to the degree of difficulty, for the purpose of defeating the enemy characters. The user can form a party using his own characters, etc., select one of the quests, and engage in battle with the enemy characters. In some cases, the character configured to be acquirable in the selected quests may be provided (or granted) during the battle.

If as the result of this battle, the quest was completed by defeating the enemy character, the character provided to the user can be acquired. The user can also perform a fusion game using the acquired character.

A lottery game in one or more embodiments is a game in which, when a user operation to execute a character lottery is accepted, a character selected from a character group subject to the lottery on the basis of lottery conditions is provided to the user. The user can use the provided character to play a battle game or a fusion game.

A fusion game in one or more embodiments is a game in which, when an operation of executing the fusion of characters is received from a user, a character serving as a fusion source (fusion source character) is combined with a character serving as a fusion resource (resource character) to strengthen the ability (strengthening fusion) of the fusion source character, or a fusion source character is grown to the next stage (evolution fusion) and thereby evolved into a fusion target character (evolved character).

The user selects fusion source characters and resource characters from among the characters he possesses, and performs strengthening fusion and evolution fusion. In strengthening fusion, instead of having the resource character taken away from the user, the ability of the fusion source character the user still possesses can be improved, or a new skill can be added. In evolution fusion, all the resource characters that have been associated with a fusion source character are fused with that fusion source character, so that instead of all the resource characters being taken away from the user, he can possess an evolved character that has been grown from the fusion source character.

<Operation>

### Specific Example 1

### (Character Selection on an Acquisition Screen)

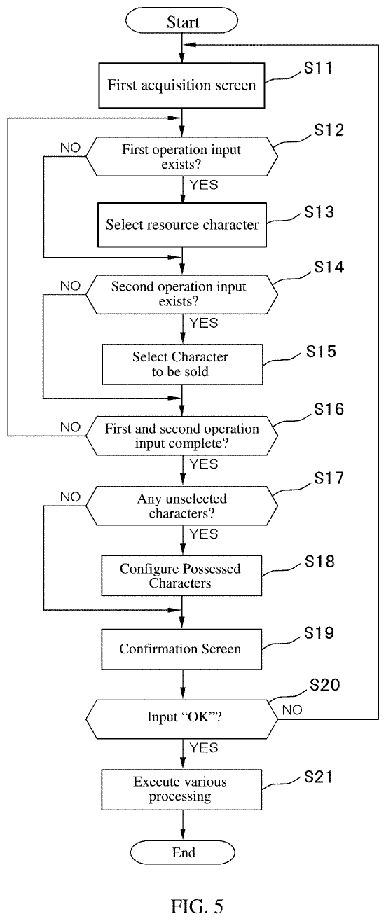

FIG. 5 is a flowchart showing an example of the processing when the user selects a character on the acquisition screen.

When the user completes a quest, the client terminal 10 transmits a first acquisition screen including one or a plurality of acquired characters (first characters), one or a plurality of fusion source characters (second characters), and a selling designation character (third character) to the screen display 160 (step S11).

Specifically, when the user completes a quest, the game execution component 101 of the client terminal 10 requests execution of completion processing by the server access component 103. Upon issuance of the request by the game execution component 101 to execute the completion processing, the server access component 103 of the client terminal 10 transmits a quest completion request together with the user ID to the server device 20.

Upon receiving the request, the request processor 201 of the server device 20 requests execution of data acquisition processing by the information management component 202. Upon issuance of the request by the request processor 201 to execute the data acquisition processing, the information management component 202 of the server device 20 refers to the user information stored in the user information storage component 222 and acquires the user information for the user corresponding to the transmitted user ID. The request processor 201 transmits the user information acquired by the information management component 202 to the client terminal 10.

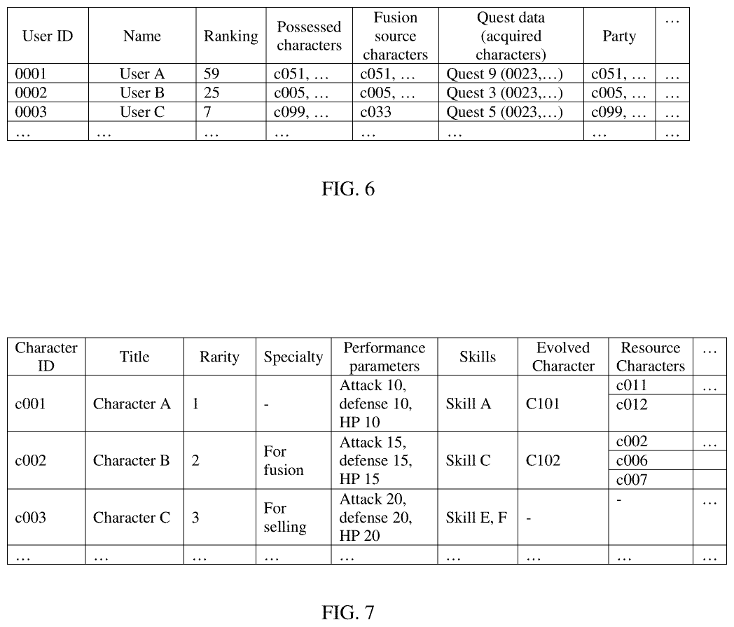

FIG. 6 is a configuration diagram showing an example of user information. The user information shown in FIG. 6 comprises categories such as user ID, name, ranking, possessed characters, fusion source characters, quest data, and party.

The user ID is information for uniquely identifying the user. The name is information indicating the user name. The ranking is information indicating the game level of the user. The category of possessed characters is information indicating the characters possessed by the user. This includes characters provided as a result of playing various quests set in the quest information stored in the quest information storage component 223, various lottery games set in lottery game information stored in the lottery game information storage component 224, and so on. Possessed characters, in short, are any of the characters set in the character information stored in the character information storage component 221. Fusion source character information is information indicating one or a plurality of fusion source characters that have been registered in advance by the user. Quest data information is information indicating a quest that is being played. Here, as shown in parentheses in the figure, one or a plurality of acquired characters provided by the providing component 102 during quest play are also configured. Party information is information indicating the characters that make up a party of the user.

FIG. 7 is a configuration diagram showing an example of character information. The character information shown in FIG. 7 comprises categories such as character ID, name, rarity, specialty, ability parameters, skills, evolved characters, and resource characters.

Character ID is information for uniquely identifying various characters. Name is information indicating the character name. Rarity is information indicating the scarcity value of the character. Here, rarity is set at one of a plurality of levels (for example, one of five levels). Specialty information is information that indicates that those are the characters that will be used for selling or for fusion, for example. Ability parameters is information indicating the abilities of the character. Here, ability values such as attack, defense, and HP are set. Skills is information indicating special skills that can be activated. Skills can be activated by using special characters as resource characters in strengthening fusion. Evolved character is information indicating the post-evolution character which is the fusion target after evolution fusion is performed. It is also possible to set two or more kinds of evolved characters for one character. Resource characters is information indicating characters that will serve as a resource and have been associated with a character as a fusion source. These resource characters become characters necessary for evolution fusion.

FIG. 8 is a configuration diagram showing an example of quest information. The quest information shown in FIG. 8 comprises categories such as quest ID, name, acquirable characters, point consumption, enemy characters, and so forth.

Quest ID is information for uniquely identifying a quest. Name is information indicating the quest title. Acquirable characters is information indicating various characters that can be acquired based on a predetermined probability when that quest has been completed. Point consumption is information indicating the number of points consumed in playing that quest. Enemy characters is information indicating the various characters that appear in that quest. This includes the enemy character set as the main boss character, and enemy characters set as sub characters other than the boss.

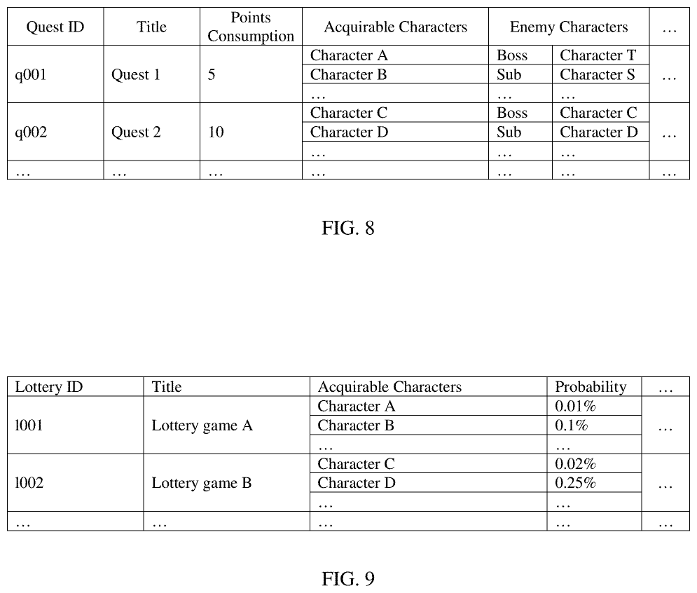

FIG. 9 is a configuration diagram showing an example of lottery game information. The lottery game information shown in FIG. 9 includes categories such as lottery ID, name, acquirable characters, and probability.

Lottery ID is information for uniquely identifying a lottery game. Name is information indicating the lottery game title. Acquirable characters is information indicating the various characters that can be acquired when that lottery game is played. Probability is information indicating the probability of that acquirable character being drawn.

Returning to FIG. 5, when the game execution component 101 of the client terminal 10 subsequently receives the information transmitted from the server device 20, it requests execution of screen display processing by the display controller 104. Upon issuance of the screen display processing request by the game execution component 101, the display controller 104 of the client terminal 10 generates a first acquisition screen based on the user information transmitted from the server device 20, and displays it on the screen display 160.

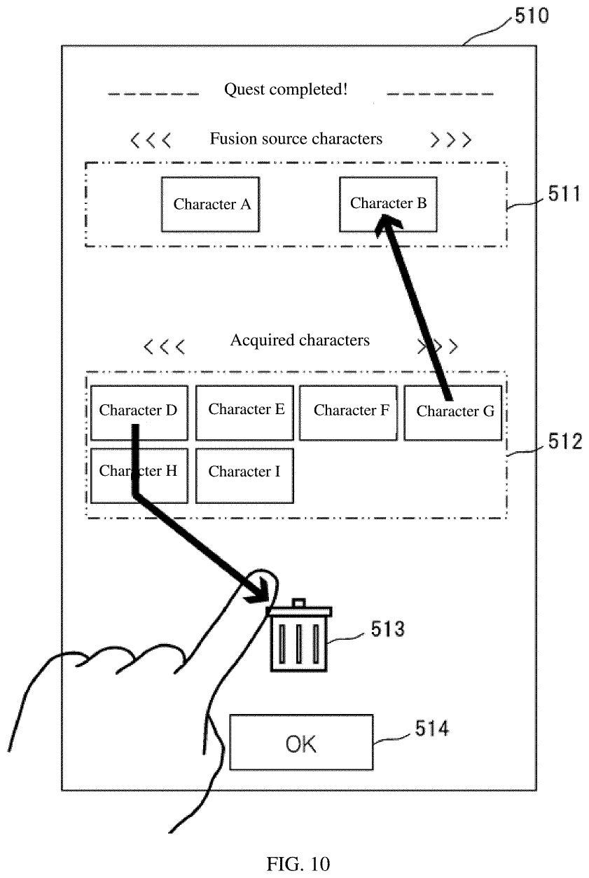

FIG. 10 is a conceptual diagram showing an example of the first acquisition screen. The first acquisition screen 510 displays a fusion source character display area 511, an acquired character display area 512, a selling designation character 513, and an operation button 514 for confirming selection of a character.

In the fusion source character display area 511 are displayed one or a plurality of fusion source characters that have been registered by the user based on the fusion source characters configured in the user information shown in FIG. 6. Here, a plurality of fusion source characters is displayed.

In the acquired character display area 512 are displayed, based on the quest data configured in the user information shown in FIG. 6, one or a plurality of characters acquired by the user by completing a quest. Here, a plurality of acquired characters is displayed.

The selling designation character 513 is a character used when selecting characters to be sold. Here, only one character (icon) in the shape of a garbage can is displayed.

Returning to FIG. 5, next, when the first acquisition screen 510 of FIG. 10 is being displayed, the display controller 104 of the client terminal 10 determines whether or not the first operation input has been accepted based on the user's operation (step S12).

This first operation input is an operation input, which the user performs by touching the touch panel, for selecting a resource character for the fusion source character displayed in the fusion source character display area 511 from among the acquired characters displayed in the acquired character display area 512.

In one or more embodiments, when the first acquisition screen 510 is being displayed, the position on the screen designated by the user moves between the display position of a certain acquired character and the display position of a certain fusion source character, and when the movement of the designated position ends at the display position of the certain acquired character or the display position of the certain fusion source character, the operation input receiver 150 receives the first operation input.

In this instance, the designated position passing through the display position of another acquired character while moving between the display position of the certain acquired character and the display position of the certain fusion source character may also enable the first operation input to be received so as to also select another acquired character as a resource character.

For example, as shown in FIG. 10, the display position of “character G” displayed in the acquired character display area 512 is touched to designate the acquired character, and the designated position is slid on the screen until reaching the display position of “character B” displayed in the character display area 511 to designate the fusion source character. Consequently, the first operation input is received by the operation input receiver 150, and an acquired “character G” is selected as a resource character of fusion source “character B.” In this instance, the display mode of the selected “character G” may be changed to enable the user to recognize it as being selected. This reduces the likelihood of accidental selection by the user.

Also, during the movement from the display position of “character G” to the display position of “character B,” the designated position does not pass through the display position of any other acquired characters. Therefore, no other acquired characters besides “character G” are selected.

The selection of “character G” as a resource character by the first operation input may occur when the finger of the user touching the screen reaches the display position of “character B,” or when the finger of the user that has reached the display position of “character B” is removed from the screen.

Also, for example, the acquired character may be designated by touching the display position of “character B” displayed in the fusion source character display area 511 to designate a fusion source character, and directly sliding the designated position on the screen to reach the display position of “character G” displayed in the acquired character display area 512. In this way, it is also possible to have the first operation input be received by the operation input receiver 150, and to have an acquired “character G” be selected as the resource character of a fusion source “character B.”

Thus, when it is determined that the first operation input produced by a user operation has been received by the operation input receiver 150 (“Yes” in step S12), the acquired character designated by the user from the acquired character display area 512 is selected as a resource character of the fusion source character designated by the user from the fusion source character display area 511 (step S13).

On the other hand, if it is determined that the first operation input produced by a user operation has not been received by the operation input receiver 150 (“No” in step S12), the flow proceeds to the processing of the subsequent step S14.

Next, when the first acquisition screen 510 of FIG. 10 is being displayed, the display controller 104 of the client terminal 10 determines whether or not a second operation input has been received based on the user operation (step S14).

The second operation input is an operation input, which the user performs by performing a touch operation on the touch panel, for selecting a character to be sold from among the acquired characters displayed in the acquired character display area 512.

In one or more embodiments, when the first acquisition screen 510 is being displayed, the position on the screen designated by the user moves between the display position of a certain acquired character and the display position of the selling designation character, and when the movement of this designated position ends at the display position of the certain acquired character or the display position of the selling designation character, the operation input receiver 150 receives the second operation input.

In this instance, the designated position passing through the display position of another acquired character while moving between the display position of the certain acquired character and the display position of the selling designated character may also enable the second operation input to be received so as to also select another first character as a selling designation character.

For example, as shown in FIG. 10, the display position of “character G” displayed in the acquired character display area 512 is touched to designate the acquired character, and the designated position is slid on the screen until reaching the display position of the selling designation character 513. In this instance, while moving from the display position of “character D” to the display position of the selling designation character 513, the designated position passes through the display position of “character H.” Consequently, the second operation input is received by the operation input receiver 150, and the acquired “character D” and “character H” are selected as characters to be sold. In this instance, the display mode of the selected “character D” and “character H” may be changed to enable the user to recognize them as being selected. This reduces the likelihood of accidental selection by the user.

The selection of “character D” and “character H” as characters to be sold by the second operation input may occur when the finger of the user touching the screen reaches the display position of the selling designation character 513 or when the finger of the user that has reached the display position of the selling designation character 513 is removed from the screen.

Also, for example, designation can be performed by touching the display position of the selling designation character 513 and directly sliding the designated position on the screen to reach the display positions of “character H” and “character D” displayed in the acquired character display area 512. With this, it is also possible to have the second operation input be received by the operation input receiver 150, and to have acquired “character H” and “character D” be selected as characters to be sold.

Thus, when it is determined that the second operation input produced by a user operation has been received by the operation input receiver 150 (“Yes” in step S14), the acquired character designated by the user from the acquired character display area 512 is selected as a character to be sold (user's desired content) (step S15).

On the other hand, if it is determined that the second operation input produced by a user operation has not been received by the operation input receiver 150 (“No” in step S14), the flow proceeds to the subsequent processing in step S16.

Next, the display controller 104 of the client terminal 10 determines whether or not the first operation input and the second operation input have been completed based on the user operation when the first acquisition screen 510 of FIG. 10 is being displayed (step S16). That is, whether or not the user selected the operation button 514 is determined when the acquisition screen 510 is displayed.

If the result of this determination is that the operation button 514 was not selected by the user (“No” in step S16), the flow returns to the processing of step S12 mentioned above, and whether or not the first operation input took place is determined again.

On the other hand, if the operation button 514 was selected by the user (“Yes” in step S16), then whether or not any acquired characters not selected by the user are still in the acquired character display area 512 (step S17) is determined.

If the result of this determination is that an acquired character not selected by the user remains in the acquired character display area 512 (“Yes” in step S17), the acquired character not selected by the user is set as a possessed character of the user (step S18).

On the other hand, if no acquired character not selected by the user remains in the acquired character display area 512 (“No” in step S17), the flow proceeds to the processing of the subsequent step S19.

Next, the display controller 104 of the client terminal 10 generates a confirmation screen on the basis of the selection status of each character set by the processing of the above steps S13, S15, and S18, and displays this on the screen display 160.

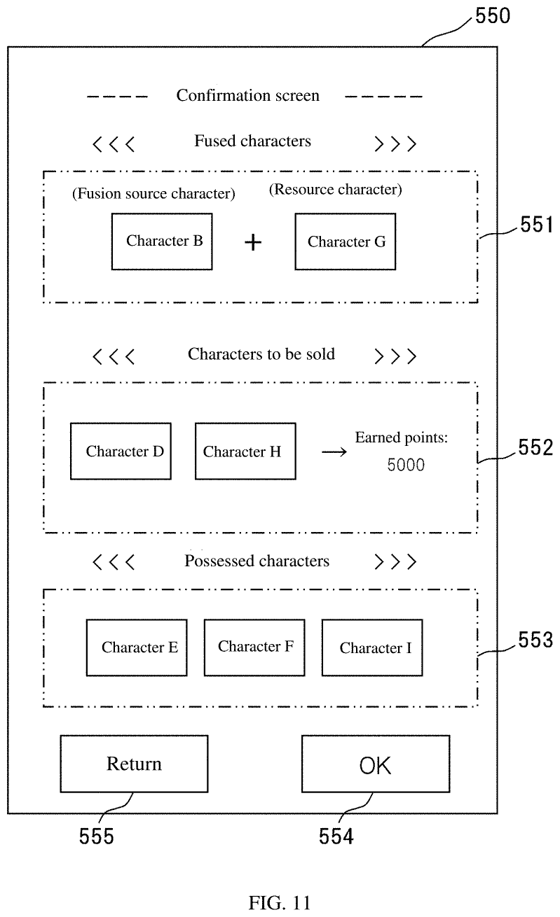

FIG. 11 is a conceptual diagram showing an example of a confirmation screen. On the confirmation screen 550 are displayed a fusion character display area 551, a selling character display area 552, a possessed character display area 553, an operation button 554 for confirming the selection of a character, and an operation button 555 for canceling the selection of a character.

In the fusion character display area 551 are displayed the fusion source character selected by the user by the first operation input, and the acquired characters serving as the fusion resources thereof. In the selling character display area 552 are displayed the acquired characters selected by the user by the second operation input as acquired characters to be sold. In the possessed character display area 553, the acquired characters not selected by the first operation input or the second operation input are displayed as possessed characters.

Going back to FIG. 5, when the confirmation screen 550 of FIG. 11 is being displayed, the display controller 104 of the client terminal 10 determines whether or not the operation button 554 has been selected based on the user operation (step S20).

If the result of this determination is that the operation button 554 was not selected by the user, that is, if the operation button 555 was selected (“No” in step S20), the flow returns to the processing of step S11 mentioned above, and an acquired character is selected again on the first acquisition screen 510.

On the other hand, if the operation button 554 was selected by the user (“Yes” in step S20), the game execution component 101 executes various processing actions related to character fusion, sale, and possession (step S21).

Subsequently, the game execution component 101 of the client terminal 10 transmits a request for character selection completion from the server access component 103 to the server device 20 together with the user information and the user ID held on the client terminal 10 side.

Upon receiving the request, the request processor 201 of the server device 20 causes the information management component 202 to update the user information stored in the user information storage component 222. Consequently, on the first acquisition screen in FIG. 10, an acquired character sold by the user's selection or an acquired character that has become a fusion resource is set as a character not possessed by the user, and the acquired characters not selected by the user are set as characters possessed by the user.

(Character Selection on Possession Screen)

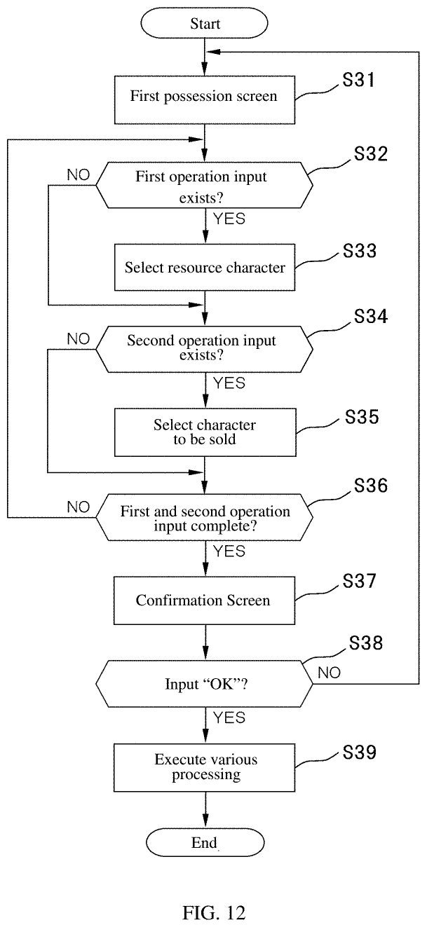

FIG. 12 is a flowchart showing an example of the processing when the user selects a character on the possession screen. Embodiments of the present invention are not limited to processing for selecting a character on the acquisition screen as described above, and can also be applied to processing for selecting a character on the possession screen.

The processing from step S32 to step S36 shown in FIG. 12 is the same as the processing from step S12 to step S16 shown in FIG. 5. Also, the processing from step S37 to step S39 shown in FIG. 12 is the same as the processing from step S19 to step S21 shown in FIG. 5. Therefore, the various processing actions after step S32 shown in FIG. 12 will be omitted.

The client terminal 10 displays on the screen display 160 a first possession screen including one or a plurality of possessed characters (first characters), one or a plurality of fusion source characters (second characters), and a selling designation character (third character), in response to the operation of the user (step S31).

Specifically, the game execution component 101 of the client terminal 10 requests the server access component 103 to execute character browsing processing in response to a user operation. When the server access component 103 of the client terminal 10 is requested by the game executing component 101 to execute the character browsing processing, a request for character browsing is transmitted to the server device 20 together with the user ID.

Upon receiving the request, the request processor 201 of the server device 20 requests the information management component 202 to execute data acquisition processing. Upon being requested by the request processor 201 to execute the data acquisition processing, the information management component 202 of the server device 20 refers to the user information stored in the user information storage component 222 and acquires the user information for the user corresponding to the transmitted user ID. The request processor 201 transmits the user information acquired by the information management component 202 to the client terminal 10.

Subsequently, upon receiving the user information transmitted from the server device 20, the game execution component 101 of the client terminal 10 requests the display controller 104 to execute screen display processing. Upon being requested by the game execution component 101 to execute the screen display processing, the display controller 104 of the client terminal 10 generates a first possession screen based on the user information transmitted from the server device 20 and displays it on the screen display 160.

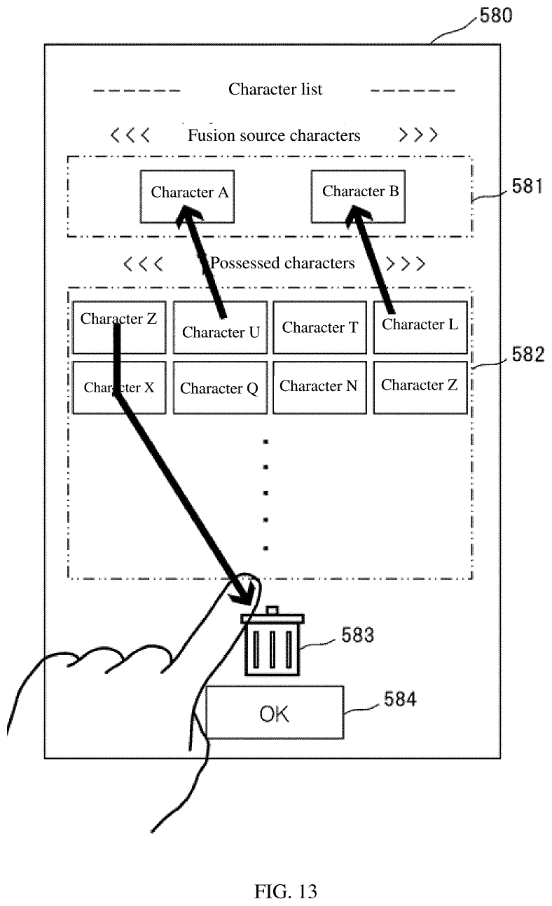

FIG. 13 is a conceptual diagram showing an example of the first possession screen. On the first possession screen 580 are displayed a fusion source character display area 581, a possessed character display area 582, a selling designation character 583, and an operation button 584 for confirming selection of a character.

In the fusion source character display area 581, one or a plurality of fusion source characters that have been registered by the user are displayed on the basis of the fusion source characters configured in the user information shown in FIG. 6. Here, a plurality of fusion source characters is displayed.

In the possessed character display area 582, one or a plurality of possessed characters acquired by the user by playing a battle game (quest) or a lottery game are displayed on the basis of the possessed characters configured in the user information shown in FIG. 6. Here, a plurality of possessed characters is displayed.

The selling designation character 583 is a character used when selecting a character to be sold. Here, only one character is displayed, which is in the form of a garbage can.

In this fashion, when the first possession screen 580 of FIG. 12 is being displayed, the user is able to select any of the possessed characters and easily perform fusion, selling, and the like by performing a first operation input or a second operation input.

Specific Example 2

### (Character Selection on Acquisition Screen)

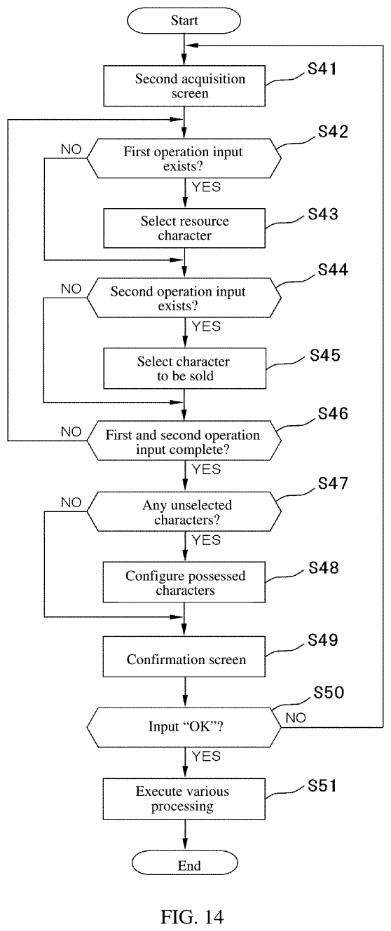

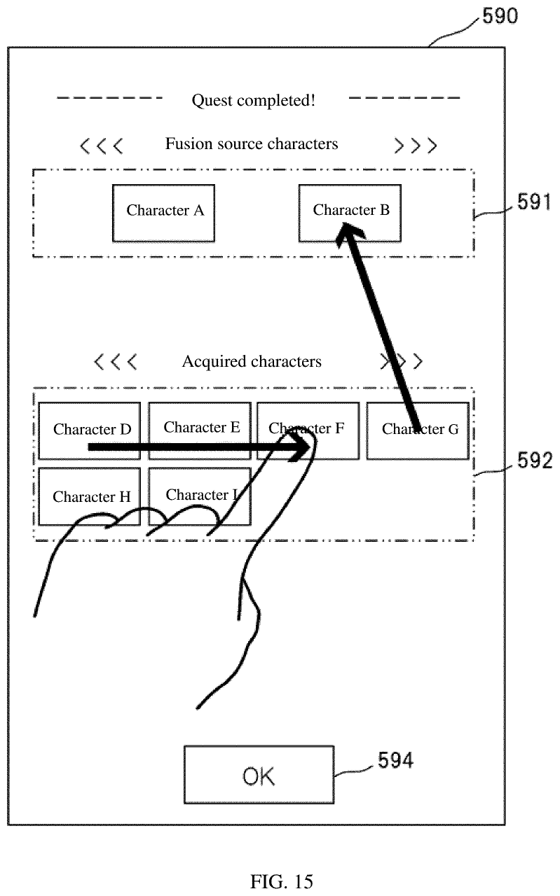

FIG. 14 is a flowchart showing another example of the processing when the user selects a character on the acquisition screen. In Specific Example 1 given above, a case in which the selling designation character (third character) is displayed on the acquisition screen was described, but in Specific Example 2, the selling designation character is not displayed on the acquisition screen.

The processing from step S45 to step S51 shown in FIG. 14 is the same as the processing from step S15 to step S21 shown in FIG. 5. Therefore, the processing after step S32 shown in FIG. 14 will not be described again.

When the user completes a quest, the client terminal 10 displays a second acquisition screen including one or a plurality of acquired characters (first characters) (reward contents) and one or a plurality of fusion characters (second characters) on the screen display section 160 (step S41).

FIG. 15 is a conceptual diagram showing an example of the second acquisition screen. On this second acquisition screen 590 are displayed a fusion source character display area 591, an acquired character display area 592, and an operation button 594 (confirmation button) for confirming the selection of a character.

Next, when the second acquisition screen 590 of FIG. 15 is being displayed, the display controller 104 of the client terminal 10 determines whether or not a first operation input has been received based on a user operation (step S42). This first operation input is the same as the above-mentioned processing of step S12 shown in FIG. 5.

As the result of the determination, if it is determined that the first operation input produced by the user operation was received by the operation input receiver 150 (“Yes” in step S42), the acquired character designated by the user from the acquired character display area 592 is selected as a resource character for the fusion source character designated by the user from the fusion source character display area 591 (step S43).

On the other hand, if it is determined that the first operation input produced by the user operation was not received by the operation input receiver 150 (“No” in step S42), the flow proceeds to the processing of the subsequent step S44.

Next, when the second acquisition screen 590 of FIG. 15 is being displayed, the display controller 104 of the client terminal 10 determines whether or not a second operation input (slide gesture input) has been received on the basis of the user operation (step S44).

The second operation input is an operation input for selecting a character to be sold (user's desired contents) from among the acquired characters (reward contents) displayed in the acquired character display area 592 by performing a touch operation (slide gesture) on the touch panel. Then, when the user touches the operation button 594 for confirming the selection of a character to be sold (user's desired contents) by the tap gesture, the display controller 104 of the client terminal 10 detects the tap gesture input based on the tap gesture and determines that the user's desired contents have been confirmed to be selected based on the detection of the tap gesture input.

In one or more embodiments, when the second acquisition screen 590 is being displayed, the position on the screen designated by the user is located at the display position of a certain acquired character, whereupon the operation input receiver 150 receives the second operation input.

In this instance, the designated position passing through the display position of another acquired character while moving between the display position of the certain acquired character and the display position of another acquired character may also enable the second operation input to be received so as to also select another first character as a character to be sold.

For example, as shown in FIG. 15, the display position of “character D” displayed in the acquired character display area 592 is touched to designate the acquired character, and the designated position is slid directly on the screen and moved to the display position of “character F.” In this instance, while moving from the display position of “character D” to the display position of “character F,” the designated position passes through the display position of “character E.” Consequently, the second operation input is received by the operation input receiver 150, and the acquired characters “character D,” “character E,” and “character F” are selected as characters to be sold. In other words, the user touches “character D,” “character E,” and “character F” continuously by the slide gesture, the client terminal 10 receives the slide gesture input where “character D,” “character E,” and “character F” have been continuously selected. In this instance, the display modes of the selected “character D,” “character E,” and “character F” may be changed to enable the user to recognize them as being selected. This reduces the likelihood of accidental selection by the user.

The selection of “character D,” “character E,” and “character F” as characters to be sold by the second operation input may occur when the finger of the user touching the screen reaches the display position of “character F,” or when the finger of the user that has reached the display position of “character F” is removed from the screen.

In this fashion, when the second acquisition screen 590 in FIG. 15 is being displayed, the user is able to select any of the acquired characters and easily perform fusion, selling, and the like by performing a first operation input or a second operation input.

(Character Selection on Possession Screen)

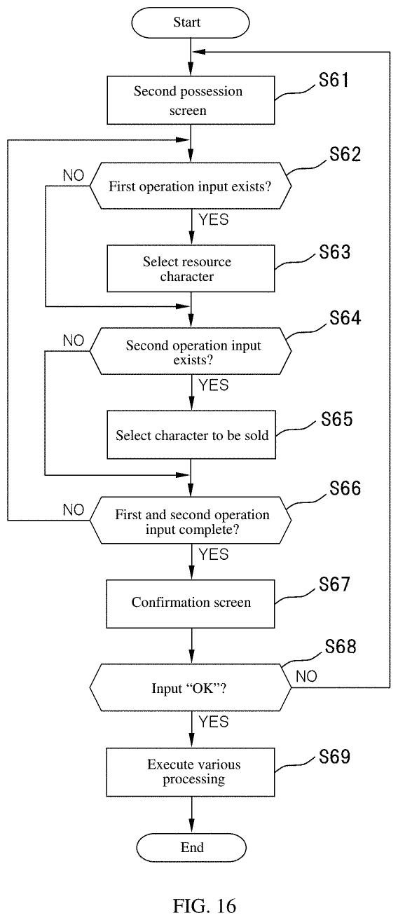

FIG. 16 is a flowchart showing an example of the processing when the user selects a character on the possession screen. Embodiments of the present invention are not limited to processing when selecting a character on the acquisition screen as described above, but can also be applied to processing when selecting a character on the possession screen. Also, in Specific Example 1 described above, an example was described where a selling designation character (third character) is displayed on the possession screen, but here in Specific Example 2 a case is described where the selling designation character is not displayed on the possession screen.

The processing from step S62 to step S36 shown in FIG. 16 is the same as the processing from step S42 to step S46 shown in FIG. 14. The processing from step S67 to step S69 shown in FIG. 16 is the same as the processing from step S49 to step S51 shown in FIG. 14. Therefore, the processing after step S62 shown in FIG. 16 will be omitted.

The client terminal 10 displays a second possession screen including one or a plurality of possessed characters (first characters) and one or a plurality of fusion source characters (second characters) on the screen display 160 (step S61).

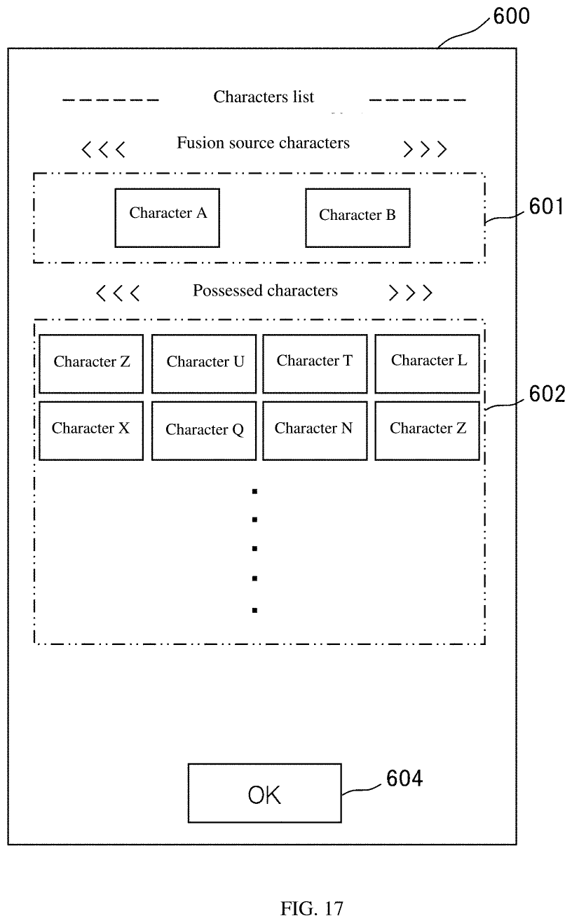

FIG. 17 is a conceptual diagram showing an example of a second possession screen. On the second possession screen 600 are displayed a fusion source character display area 601, a possessed character display area 602, and an operation button 604 for confirming the selection of a character.

In the fusion source character display area 601, one or a plurality of fusion source characters that have been registered by the user are displayed based on the fusion source characters configured in the user information shown in FIG. 6. Here, a plurality of fusion source characters is displayed.

In the possessed character display area 602, one or a plurality of possessed characters that were acquired by the user by playing a battle game (quest) or a lottery game are displayed based on the possessed characters configured in the user information shown in FIG. 6. Here, a plurality of possessed characters is displayed.

In this fashion, when the second possession screen 600 of FIG. 16 is being displayed, the user is able to select any of the acquired characters and easily perform fusion, selling, and the like by performing a first operation input or a second operation input.

Specific Example 3

(Character Selection on Acquisition Screen)

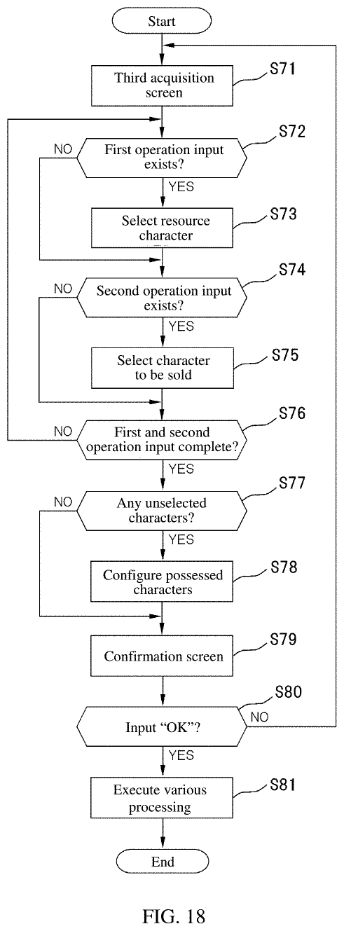

FIG. 18 is a flowchart showing another example of the processing when the user selects a character on the acquisition screen. In Specific Example 3, unlike Specific Example 1 and Specific Example 2 described above, acquired characters are displayed by being classified on the acquisition screen.

The processing from step S72 to step S81 shown in FIG. 18 is the same as the processing from step S12 to step S21 shown in FIG. 5. Therefore, the processing after step S72 shown in FIG. 18 will be omitted.

When the user completes a quest, the client terminal 10 displays on the screen display 160 a third acquisition screen including one or a plurality of acquired characters (first characters), one or a plurality of fusion source characters (second characters), and a selling designation character (third character) (step S71).

Specifically, when the user completes a quest, the game execution component 101 of the client terminal 10 requests the server access component 103 to execute completion processing. Upon being requested by the game execution component 101 to execute completion processing, the server access component 103 of the client terminal 10 transmits a request for quest completion together with the user ID to the server device 20.

Upon receiving the request, the request processor 201 of the server device 20 requests execution of data acquisition processing from the information management component 202. Upon issuance of the request by the request processor 201 to execute data acquisition processing, the information management component 202 of the server device 20 refers to the user information stored in the user information storage component 222 and acquires the user information for the user corresponding to the transmitted user ID. Also, the information management component 202 refers to the character information stored in the character information storage component 221 and acquires character information for each acquired character included in the quest data set in the acquired user information. The request processor 201 transmits the user information and the character information acquired by the information management component 202 to the client terminal 10.

Subsequently, upon receiving the information transmitted from the server device 20, the game execution component 101 of the client terminal 10 requests the execution of screen display processing from the display controller 104. Upon issuance of the request by the game execution component 101 to execute screen display processing, the display controller 104 of the client terminal 10 generates a third acquisition screen based on the user information and the character information transmitted from the server device 20 and displays it on the screen display 160.

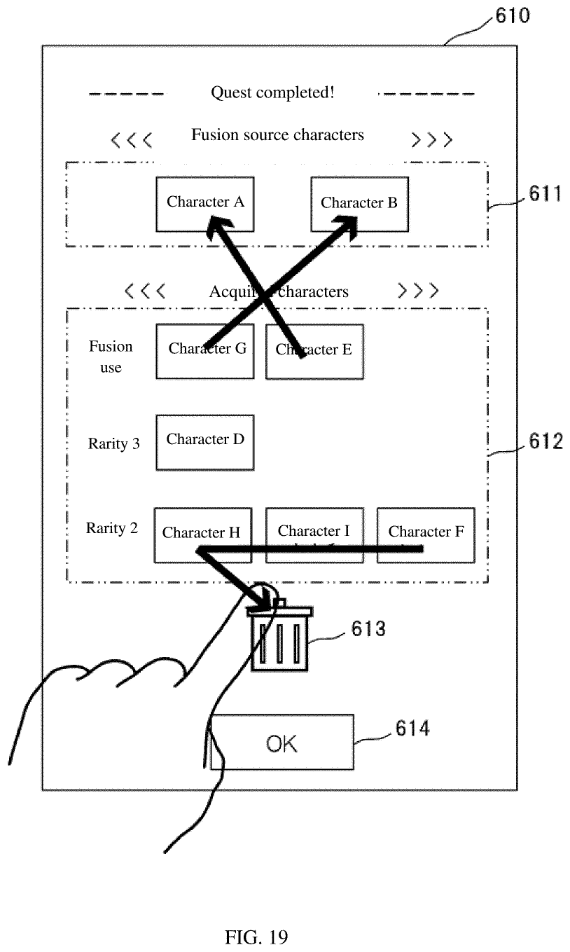

FIG. 19 is a conceptual diagram showing an example of the third acquisition screen. On the third acquisition screen 610 are displayed a fusion source character display area 611, an acquired character display area 612, a selling designation character 613, and an operation button 614 for confirming the selection of a character.

In the fusion source character display area 611, one or a plurality of fusion source characters registered by the user are displayed on the basis of the fusion source characters configured in the user information shown in FIG. 6. Here, a plurality of fusion source characters is displayed.

In the acquired character display area 612, one or a plurality of acquired characters acquired by the user by completing a quest are displayed, based on the quest data configured in the user information shown in FIG. 6. Here, a plurality of acquired characters is displayed.

In the acquired character display area 612, the display position of a fusion-use acquired character is placed closer to the display position of the fusion source characters based on the specialty set in the character information shown in FIG. 7. Therefore, the travel distance from an acquired character with a high probability of becoming a fusion resource to the fusion source characters displayed in the fusion source character display region 611 is shorter, making it easier to select a character as a fusion resource.

In the acquired character display area 612, based on the rarity set in the character information shown in FIG. 7, the lower the rarity setting for an acquired character, the closer its display position is to the selling designation character 613. That is, the display position of an acquired character is controlled to change according to the rarity set for the acquired character. Therefore, the travel distance from an acquired character with a high probability of being sold to the selling designation character 613 is shorter, making it easier to select a character to be sold.

The selling designation character 613 is a character used when selecting characters to be sold. Here, only one character in the shape of a garbage can is displayed.

In this fashion, when the third acquisition screen 610 in FIG. 19 is being displayed, the user is able to select any of the acquired characters and easily perform fusion, selling, and the like by performing a first operation input or a second operation input.

In Specific Example 3, it is also possible to select an acquired character to be sold by not displaying the selling designation character 613 on the third acquisition screen 610 as shown in the Specific Example 2 described above.

Specific Example 4

### (Character Selection on Acquisition Screen)

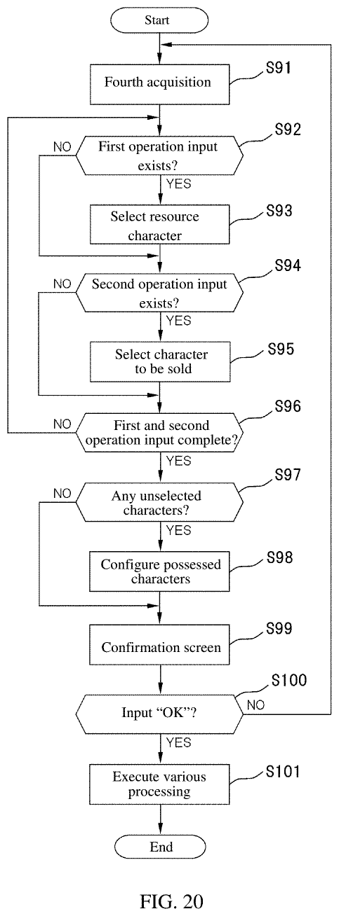

FIG. 20 is a flowchart showing another example of the processing when the user selects a character on the acquisition screen. In Specific Example 4, unlike Specific Examples 1 to 3 described above, fusion source characters having the same skill as the acquired characters are displayed on the acquisition screen.

The processing from step S92 to step S101 shown in FIG. 20 is the same as the processing from step S12 to step S21 shown in FIG. 5. Therefore, the processing after step S92 shown in FIG. 20 will be omitted.

When the user completes a quest, the client terminal 10 displays on the screen display 160 a fourth acquisition screen including one or a plurality of acquired characters (first characters), one or a plurality of fusion source characters (second characters), and a selling designation character (third character) (step S91).

Specifically, when the user completes a quest, the game execution component 101 of the client terminal 10 requests execution of completion processing from the server access component 103. Upon issuance of the request by the game execution component 101 to execute completion processing, the server access component 103 of the client terminal 10 transmits a request for quest completion together with the user ID to the server device 20.

Upon receiving the request, the request processor 201 of the server device 20 requests execution of data acquisition processing from the information management component 202. Upon issuance of the request by the request processor 201 to execute data acquisition processing, the information management component 202 of the server device 20 refers to the user information stored in the user information storage component 222 and acquires user information for the user corresponding to the transmitted user ID. Also, the information management component 202 refers to the character information stored in the character information storage component 221 and acquires character information about each acquired character included in the quest data set in the acquired user information. Furthermore, the information management component 202 refers to the character information and the user information and acquires the possessed character having the same skill as the acquired character. The request processor 201 transmits user information, character information, and the like acquired by the information management component 202 to the client terminal 10.

Subsequently, upon receiving the information transmitted from the server device 20, the game execution component 101 of the client terminal 10 requests execution of screen display processing from the display controller 104. Upon issuance of the request by the game execution component 101 to execute screen display processing, the display controller 104 of the client terminal 10 generates a fourth acquisition screen based on the user information, the character information, and the like transmitted from the server device 20 and displays it on the screen display 160.

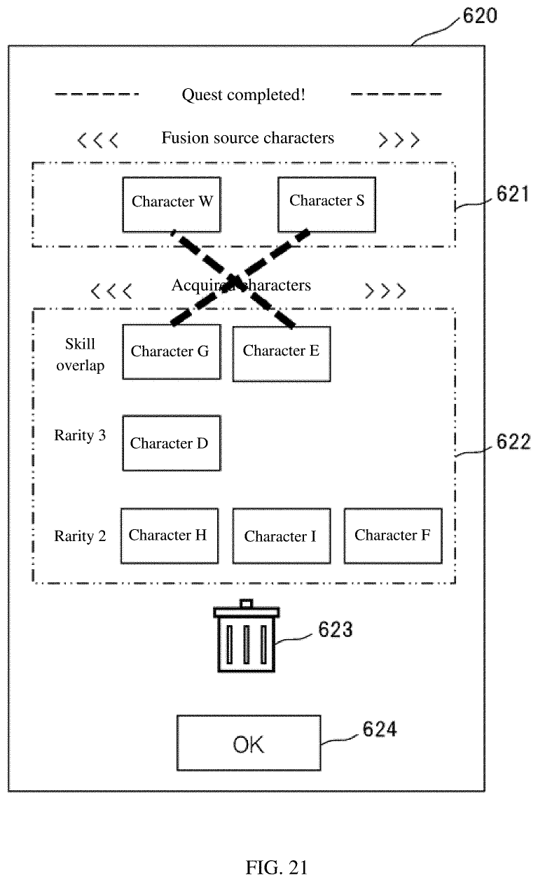

FIG. 21 is a conceptual diagram showing an example of the fourth acquisition screen. On the fourth acquisition screen 620 are displayed a fusion source character display area 621, an acquired character display area 622, a selling designation character 623, and an operation button 624 for confirming selection of a character.

In the fusion source character display area 621 are displayed possessed characters having the same skill as the acquired characters in the acquired character display area 622 based on the user information shown in FIG. 6 and the character information shown in FIG. 7. Here, a plurality of possessed characters is displayed.

In the acquired character display area 622 are displayed one or a plurality of acquired characters acquired by the user by completing a quest, based on the quest data configured in the user information shown in FIG. 6. Here, a plurality of acquired characters is displayed.

In the acquired character display area 622, the display position of an acquired character having a skill is placed closer to the fusion source character display area 621 based on the skill that is set in the character information shown in FIG. 7. Also, possessed characters and acquired characters having the same skill are connected by auxiliary lines. This makes it easier to fuse characters having the same skill. In addition, the skill level of possessed characters serving as a fusion source can be increased by using acquired characters having the same skill as a fusion resource. When the skill level of a possessed character as a fusion source is at its maximum, it may be placed so that it is not near the fusion source character display area 621.

In the acquired character display area 622, based on the rarity set in the character information shown in FIG. 7, the lower the rarity setting for an acquired character, the closer its display position is to the selling designation character 623. Therefore, the travel distance from an acquired character with a high probability of being sold to the selling designation character 623 is shorter, making it easy to select a character to be sold.

The selling designation character 623 is a character used when selecting a character to be sold. Here, only one character is displayed, which is in the form of a garbage can.

In this fashion, when the fourth acquisition screen 620 in FIG. 21 is being displayed, the user is able to select any of the acquired characters and easily perform fusion, selling, and the like by performing a first operation input or a second operation input.

### SUMMARY

As described above, according to the information processing system 1 pertaining to the previously described embodiments, any of the acquired characters or possessed characters may be selected, and character fusion, selling, and so forth may be performed with ease while an acquisition screen or a possession screen is being displayed. Therefore, even when a plurality of operation categories for a character, such as character fusion, selling, and the like exist, each operation is performed effortlessly. As a result, the various operations performed by the user are simplified, enabling improved operability.

### Other Embodiments

The previously described embodiments are intended to facilitate an understanding of the present invention and should not be construed as limiting the present invention. The present invention can be modified and improved upon without departing from the spirit of the invention, and equivalents thereof are also included in the present invention. In particular, the following embodiments described below are also encompassed by the present invention.

<Acquisition Screen/Possession Screen>

In the previously described embodiments, the screen display may be controlled so that the size of the character display area is changed according to the number of characters displayed in the fusion source character display area on the acquisition screen or the possession screen. For example, the display controller 104 may control the screen display so that the display area of a character increases as the number of characters displayed in the fusion source character display area decreases. This makes it easier to designate a character displayed in the fusion source character display area, and reduces the likelihood of accidental operation by the user.

Also, in the previously described embodiments, the number of characters displayed in the acquired character display area may also be displayed.

Also, in the previously described embodiments, when an acquisition screen or possession screen is being displayed, the display mode of the character selected by a first operation input or a second operation input may be changed. For example, the display mode may be varied so that a character selected by a first operation input is displayed in red, while a character selected by a second operation input is displayed in green, enabling the characters to be distinguished from one another. This reduces the likelihood of accidental selection by the user.

Also, in the previously described embodiments, when an acquisition screen or possession screen is being displayed, the display may be controlled so as to couple the characters as fusion resources selected by a first operation input with to the fusion source characters using auxiliary lines. It is also possible to perform display control so as to couple the characters to be sold selected by a second operation input with the selling designation characters using auxiliary lines. This reduces accidental selection by the user.

Also, in the previously described embodiments, a case was used as an example and described in which a plurality of acquired characters earned as a play result are displayed on the acquisition screen when a quest is completed and become the object of the first operation input and the second operation input, but embodiments of the present invention is not limited to or by this. For example, at the end of a lottery game, a plurality of acquired characters earned as a play result may be displayed on the acquisition screen and may become the object of the first operation input and the second operation input.

<First Operation Input/Second Operation Input>

In the previously described embodiments, it is also possible to configure it in such a way that the first operation input is received and the acquired character selected as the character serving as the fusion resource by a flick to the right (upward flick) in the display position of an acquired character, and a second operation input is received and the acquired character is selected as a character to be sold by a flick to the left (downward flick) in the display position of the acquired character. In this instance, the first operation input and the second operation input may be made customizable through user settings. Also in this instance, after the selection, a switch to a selection screen for fusion source characters may occur (for example, a possession screen) where the user is allowed to select any of the fusion source characters.

Also, in the previously described embodiments, when the acquisition screen or possession screen is being displayed, the user may be allowed to cancel the selection by once again tapping the display position of the character selected by the first operation input or the second operation input. Also, cancellation of the character being selected may occur when the user's finger touching the screen reaches a cancel area in the screen (the outer frame of the screen, a blank area, etc.), or at the point when the user's finger is removed from the screen.

Also, in the previously described embodiments, when the acquisition screen or the possession screen is being displayed, the user may be allowed to lock the selection by once again double tapping the display position of the character selected by the first operation input or the second operation input to keep the selection from being cancelled.

<Content>

In the previously described embodiments, a character is set as character information, but the content is not limited to this. For example, the content may be an item, a card, a figure, an avatar, an ion, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 information processing system

10 client terminal

20 server device

50 computer

51 CPU

52 RAM

53 ROM

54 communication interface

55 input device

56 display device

57 external interface

58 HDD

100 client controller

101 game execution component

102 providing component

103 server access component

104 display controller

120 client storage component

140 client communication component

150 operation input receiver

160 screen display

200 server controller

201 request processor

202 information management component

220 server storage component

221 character information storage component

222 user information storage component

223 quest information storage component

224 lottery game information storage component

240 server communication component

510 first acquisition screen

511 fusion source character display area

512 acquired character display area

513 selling designation character

514 operation button

550 confirmation screen

551 fusion character display area

552 selling character display area

553 possessed character display area

554 operation button

555 operation button

580 first possession screen

581 fusion source character display area

582 possessed character display area

583 selling designation character

584 operation button

590 second acquisition screen

591 fusion source character display area

592 acquired character display area

594 operation button

600 second possession screen

601 fusion source character display area

602 possessed character display area

604 operation button

610 third acquisition screen

611 fusion source character display area

612 acquired character display area

613 selling designation character

614 operation button

620 fourth acquisition screen

621 fusion source character display area

622 acquired character display area

623 selling designation character

624 operation button

B bus line

N network

What is claimed is:

1. An information processing device that executes a game comprising:
a receiver that receives a slide gesture input and a tap gesture input based on a user's operation on a touch panel that displays a screen of the game; and
a processor that:
once the user completes a quest of the game, causes the touch panel to display reward contents to be acquired by the user and a confirmation button spaced apart from each of the reward contents;
upon detecting the slide gesture input, determines that user's desired contents have been continuously selected from the reward contents; and
upon detecting the tap gesture input, determines that the user's desired contents have been confirmed to be selected as selling contents, wherein
the slide gesture input is based on a slide gesture of the user by which the user's desired contents have been continuously touched,
the tap gesture input is based on a tap gesture on the confirmation button, and
a first space between each of the reward contents and the confirmation button is at least a size of each of the reward contents.

2. The information processing device according to claim 1, wherein a second space between each of the reward contents is smaller than the first space.

3. The information processing device according to claim 1, wherein in the slide gesture, a touch position is slid on the screen until the touch position reaches all of the user's desired contents.

4. The information processing device according to claim 3, wherein the touch position is slid on the confirmation button before the tap gesture.

5. The information processing device according to claim 3, wherein the touch position is slid on the first space.

6. The information processing device according to claim 3, wherein the touch position is slid on a second space between each of the reward contents.

7. A method to execute a game on a computer, the method comprising:
receiving a slide gesture input and a tap gesture input based on a user's operation on a touch panel that displays a screen of the game;
once the user completes a quest of the game, causing the touch panel to display reward contents to be acquired by the user and a confirmation button spaced apart from each of the reward contents;
detecting the slide gesture input based on a slide gesture of the user by which user's desired contents among the contents have been continuously touched;
determining that the user's desired contents have been continuously selected from the reward contents based on the detection of the slide gesture input;
detecting the tap gesture input based on a tap gesture on the confirmation button; and
determining that the user's desired contents have been confirmed to be selected as selling contents based on the detection of the second input, wherein
a first space between each of the reward contents and the confirmation button is at least a size of each of the reward contents.

8. The method according to claim 7, wherein a second space between each of the reward contents is smaller than the first space.

9. The method according to claim 7, wherein in the slide gesture, a touch position is slid on the screen until the touch position reaches all of the first contents.

10. The method according to claim 9, wherein the touch position is slid on the confirmation button before the tap gesture.

11. The method according to claim 9, wherein the touch position is slid on the first space.

12. The method according to claim 9, wherein the touch position is slid on a second space between each of the reward contents.
